(19) United States
(12) Patent Application Publication
(10) Pub. No.: US 2006/0255493 A1
(43) Pub. Date: Nov. 16, 2006

(54) Apparatus and method for making form-fitted molded protective cases for products

(75) Inventor: Afshin Fouladpour, Danville, CA (US)

Correspondence Address: BEYER WEAVER & THOMAS, LLP, P.O. BOX 70250, OAKLAND, CA, 94612-0250, US

(73) Assignee: Sik, Inc., Redwood City, CA (US)

(21) Appl. No.: 11/127,402

(22) Filed: May 11, 2005

(51) Int. Cl. B29C 51/00; B29C 37/00

(52) U.S. Cl. 264/161; 264/132; 264/553; 264/320; 264/322; 264/544; 264/314

(57) ABSTRACT

A method and apparatus for making inexpensive, form-fitted, protective cases of thermal plastic or polycarbonate material that can be easily printed with decorative imagery and/or electronic circuitry for a variety of products, such as portable music players or radios, cell phones, lap-top computers, and the like. The method involves creating a tool having substantially the same surface dimensions of a product. An element is then molded from bulk film of thermoplastic material using the tool. Once the element is molded, it is trimmed from the bulk film. The resulting apparatus is a protective case intended to form-fit over the surface features and dimensions of the actual product used to define the tool.

### FIELD OF THE INVENTION

The present invention relates generally to the making of form-fitted, molded protective cases for products, and more particularly, to a method and apparatus for making inexpensive, form-fitted, protective cases made from a polycarbonate or thermoplastic material that can be readily printed with decorative imagery and/or electronic circuitry. The protective cases can be made for a variety of products, such as portable music players, radios, cell phones, lap-top computers, and the like.

### BACKGROUND OF THE INVENTION

A variety of consumer electronic products, such as portable music players like the Ipod™ from Apple Computer, lap-tops, cell phones, etc., have become extremely popular in recent years. Since these devices are all portable, they are typically carried or otherwise accompany a person to and from work, while traveling, working out or exercising, socializing, etc. The portability of these products makes them convenient, but typically at the expense of added wear and tear on the product. Very often these products are dropped by accident, get bang or bounced around, causing the exterior to be scratched or damaged. For some products, it is known to use a carrying case to both carry and protect the product. These cases, however, are typically made of leather, silicon rubber, or nylon, are non-decorative, and are clumsy to use. It is often difficult to insert and remove the product from the case.

Both manufacturers and consumers of many portable electronic devices are also extremely brand conscience. For example, companies like Apple Computer and Nokia have developed very strong brand awareness associated with their Ipod™ and cell phone product offering respectively. These organizations go to great lengths to appropriately brand their products with decorative company logos, trademarks, and the like.

One known method of forming art work on the exterior case of a product is called In Mold Decoration or (IMD). With this technique, a hard plastic element that is shaped to form-fit over a product or a portion of a product is created. The hard plastic element may be formed in a number of ways, for example by milling, using a mold, etc. After the element has been fabricated, it is placed into a mold with a film containing the art work. Structural plastic is then injected into the mold, causing the hard element and the film containing the art work to bond. After removal from the mold, the element with the bonded art work is then placed onto the product or portion of the product it was intended to cover. The element with the art work typically becomes an integral part of the product, meaning it is affixed to the product in some way, such as snapping or screwing it onto the body of the product. While beneficial, the aforementioned process has a number of drawbacks. Foremost it is very expensive. The hardened element must be made for each product. This will often require the creation of a specific mold for each element to be used with a product. Secondly, since the element becomes an integral part of the product, it does not provide a protective cover for the product.

Accordingly, a method and apparatus for making inexpensive, form-fitted, protective cases of polycarbonate or thermal plastic material that can be easily printed with decorative imagery and/or electronic circuitry for a variety of products, such as portable music players or radios, cell phones, lap-top computers, and the like, is therefore needed.

### SUMMARY OF THE INVENTION

To achieve the foregoing, and in accordance with the purpose of the present invention, a method and apparatus for making inexpensive, form-fitted, protective cases of thermal plastic or polycarbonate material that can be easily printed with decorative imagery and/or electronic circuitry for a variety of products, such as portable music players or radios, cell phones, lap-top computers, and the like, is disclosed. The method involves creating a tool having substantially the same surface dimensions of a product. An element is then molded from bulk film of thermoplastic material using the tool. Once the element is molded, it is trimmed from the bulk film. The resulting apparatus is a protective case intended to form-fit over the surface features and dimensions of the actual product used to define the tool. In various embodiments, the bulk film can be pre-printed with a decorative image or electronic circuit prior to molding. As a result, the image or circuitry appears on the element after it is molded.

### BRIEF DESCRIPTION OF THE DRAWINGS

The invention, together with further advantages thereof, may best be understood by reference to the following description taken in conjunction with the accompanying drawings in which:

FIG. 1 is a diagram of an music player tool used for fabricating protective cases according to the present invention.

FIG. 2 is a diagram of a protective case made by the tool of FIG. 1 according to the present invention.

FIG. 3 is a diagram for fabricating the protective case according to one embodiment of the present invention.

FIG. 4 is a diagram for fabricating the protective case according to another embodiment of the present invention.

FIG. 5 is a diagram for fabricating the protective case according to another embodiment of the present invention.

FIG. 6 is a diagram for fabricating the protective case according to another embodiment of the present invention.

FIG. 7 is a diagram for fabricating the protective case according to another embodiment of the present invention.

FIG. 8 is a diagram showing a molded element before being trimmed from the bulk film according to one embodiment of the present invention.

FIG. 9 is a diagram illustrating the trimming of the molded element from the bulk film according to the present invention.

FIGS. 10A and 10B illustrate a sheet of bulk material and a molded element fabricated thereon having a decorative logo printed thereon respectively according to the present invention.

FIG. 11 illustrates a molded element with a printed logo fitted over an Apple Ipod™.

FIG. 12 illustrates a molded element having a conductive circuit printed thereon according to the present invention.

FIG. 13 is a flow diagram illustrating the sequence of making the protective case of the present invention.

FIG. 14 is a diagram illustrating the receipt and printing of an image onto the bulk film used to make the molded elements according to the present invention.

In the Figures, like reference numbers refer to like components and elements.

### DETAILED DESCRIPTION OF THE INVENTION

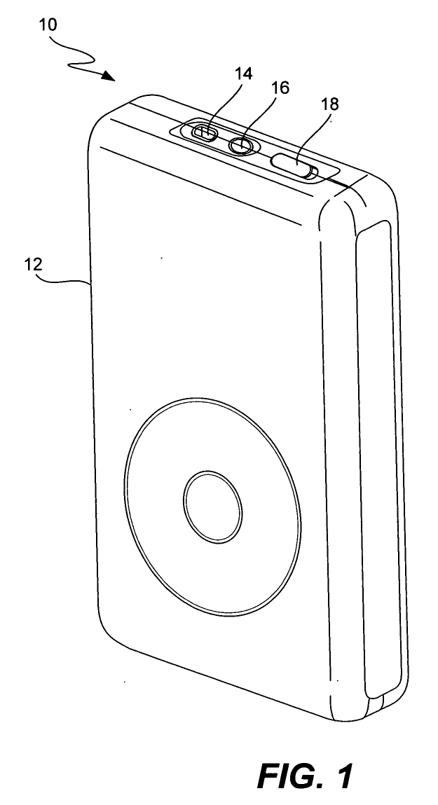

Referring to FIG. 1, a diagram of a tool of a music player used for fabricating protective cases for an actual music player according to the present invention is shown. The tool 10, for the sake of illustration, resembles an Apple Ipod™. The tool can be made from a variety of materials such as plastic, metal, wood, etc. The tool can also be fabricated in a variety of ways, including milling, molding or three dimensional printing The key feature of the tool is that its external features and dimension be substantially identical to the actual product the case is intended to cover and protect. In the illustrated example for instance, the tool includes a surface bump 12 having substantially the same height and diameter as the “Apple Click Wheel”, and openings 14, 16 and 18, corresponding to the hold switch, remote port and headphone jacks on an actual Apple Ipod™ respectively. It should be noted that the tool 10 as shown is merely illustrative. In accordance with the present invention, the tool could be shaped to be substantially similar to virtually any product or object.

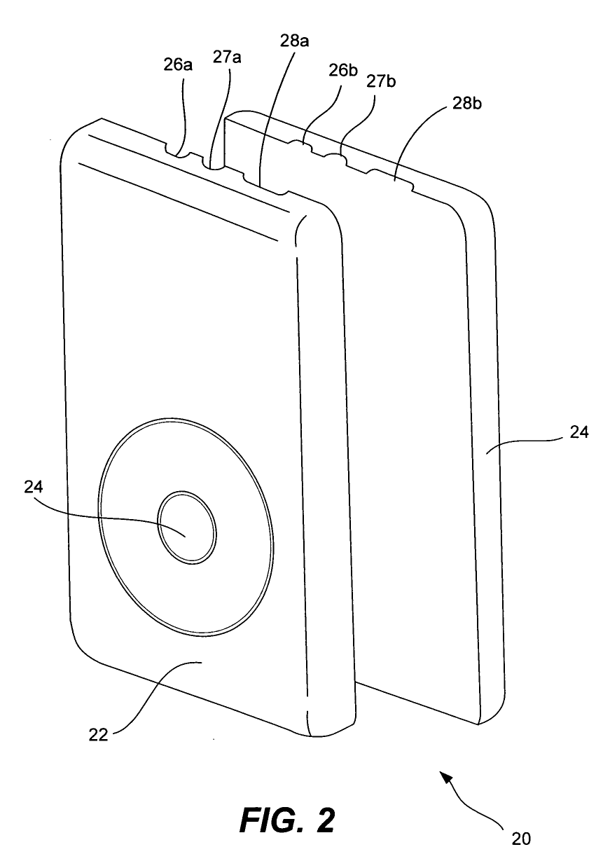

Referring to FIG. 2, a diagram of a protective case according to the present invention is shown. The tool 10 is used to mold the protective case 20 so that it will form-fit an actual Apple Ipod™. The protective case 20 includes a front member 22 intended to be placed over the front of an actual Ipod™ and a second back member 24 intended to be placed over the back of the Ipod™. The front member 22 includes a surface bump 24 to accommodate the Click Wheel of the Ipod™. Both the front member 22 and back member 24 include recess regions 26a, 27a, and 28a and 26b, 27b, and 28b to accommodate the hold switch, remote port and headphone jacks on an actual Apple Ipod™ respectively.

In various embodiments, the two members 22 and 24 of the protective case 20 are made from a bulk film of a thermoplastic or polycarbonate material. A thermoplastic is any plastic material that becomes soft and compliable when heated and hard when cooled. Examples of thermoplastics that can be used with the present invention include acrylonitrile butadiene styrene, polyvinyl chloride (PVC), polypropylene, acrylic, celluloid, etc. A polycarbonate is a class of thermoplastics characterized by high-impact strength and light weight. The material can be either clear, colored, or opaque. In one specific embodiment, the material used is a thermoplastic such as Lexan™, available from General Electric Corporation. As described in more detail below, the raw material used to make the protective case 20 is initially in large bulk film form. The film is subsequently molded, using any one of a variety of machines and techniques, that rely on pressure, heat, or a combination thereof, to mold the material to the shape of the tool 10. A trimming machine is then used to excise or cut the case 20 from the bulk film.

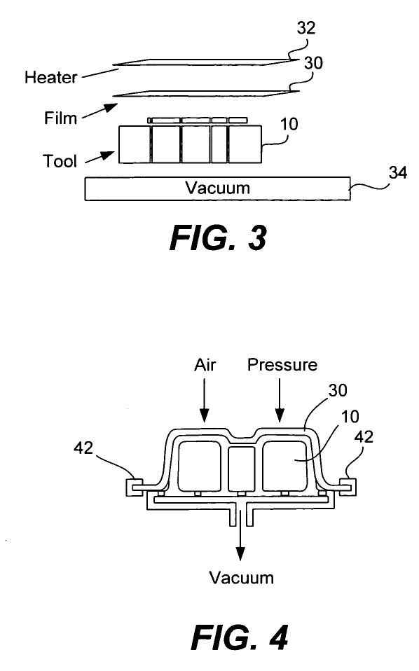

Referring to FIG. 3 a diagram of a machine used for fabricating the protective case according to one embodiment of the present invention is shown. In this embodiment, a film 30 is placed over the tool 10. A heating element 32 is then used to heat the film 30 and tool 10 while a vacuum 34 is used to pull the film 30 onto the tool 10. This process is highly versatile and inexpensive. Both male and female shaped tools can be used.

Referring to FIG. 4, a diagram for fabricating the protective case according to another embodiment of the present invention is shown. This embodiment relies on pressure to assist in the molding process and is more advanced than simply using heat and a vacuum. In this process, a clamp 42 is used to clamp the film 30 over the tool 10. Air pressure is then applied to the top of the film while a vacuum is applied to the bottom of the film. This results in improved molding definition, increased consistency, and better replication for a better fit. Both male and female molds can be used.

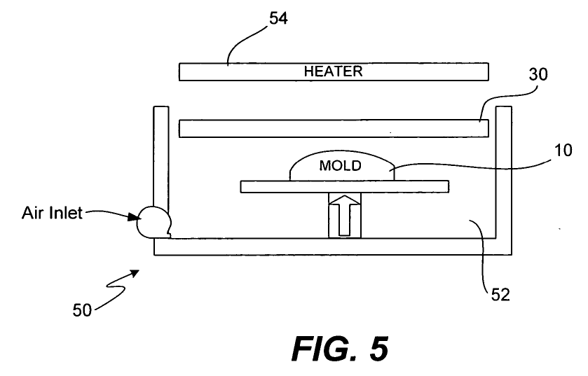

Referring to FIG. 5, a diagram for fabricating the protective case according to another embodiment of the present invention is shown. In this embodiment, a zero gravity fabrication machine 50 is used. The fabrication machine 50 includes a vacuum chamber 52. The tool 10 is placed within the chamber 52 and the film 30 is placed over the tool 10 and under a heating element 54. Air is then purposely introduced inside the chamber 52 to compensate for the natural sag of the heated film 30. The zero gravity fabrication machine 50 tends to retain the uniformity of the film thickness after the protective case has been fabricated. This technique is particularly useful for the fabrication of large protective cases.

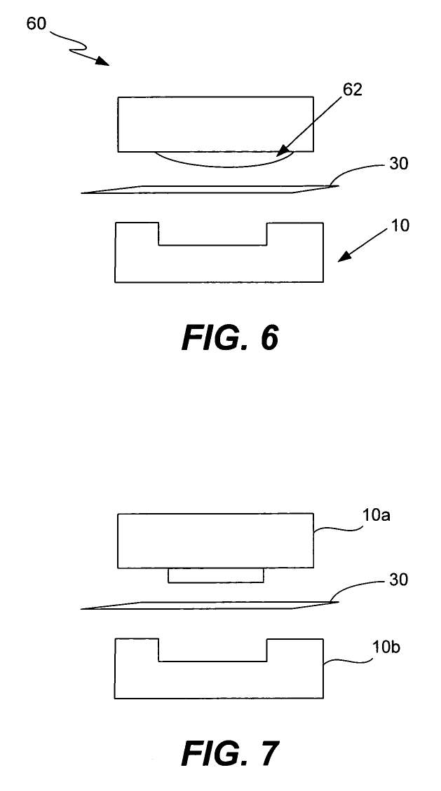

Referring to FIG. 6, a diagram for fabricating the protective case according to another embodiment of the present invention. In this embodiment, a hydro-forming tool 60 uses a pressurized bladder 62 to exert pressure and force the film 30 onto the tool 10. The pressure causes the film 30 to assume the shape of the tool 10.

Referring to FIG. 7, a diagram for fabricating the protective case according to another embodiment of the present invention is shown. In this embodiment, the film 30 is squeezed between a male tool 10a and a female tool 10b. The pressure on the film 30 created during the squeezing action causes the film 30 to assume the shape of the tools 10a and 10b.

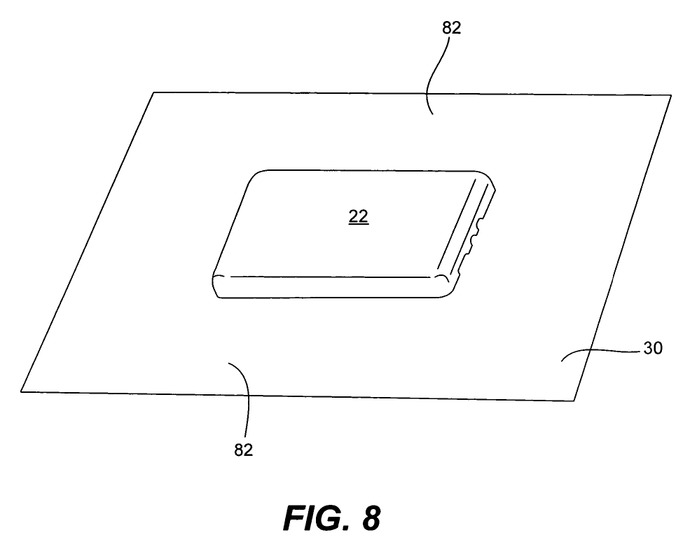

Referring to FIG. 8, a diagram illustrating a molded sheet 30 including a molded element 22 formed thereon is shown. The element can be molded using any of the aforementioned machines or methods. The molded sheet has excess bulk material 82 surrounding the molded element 22. It should be noted that in the embodiment illustrated, only a single element 22 is shown. It should be understood that according to other embodiments, multiple elements 22 or 24 could be fabricated on the sheet 30, either serially or in parallel. When the element is molded in a serial fashion, the bulk sheet 30 is typically stepped, aligned, and molded. This sequence is repeated over and over. Alternatively, the elements 22 and/or 24 could be molded in parallel using a machine capable of molding one or more elements simultaneously. With such a machine, the film would again be stepped, aligned, and then multiple elements would simultaneously be molded in the machine.

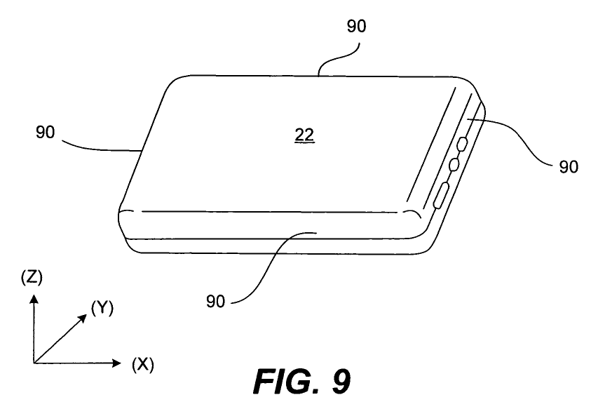

Referring to FIG. 9, a diagram illustrating the element 22 trimmed from the bulk sheet 30 is shown. According to various embodiments, the trimming machine used to excise the element 22 from the sheet 30 can be capable of either cutting in two dimensions in the X and Y directions or cutting in three dimensions along the X, Y and Z directions. In the example illustrated, the element 22 is trimmed or cut from the sheet 30 along the Z axis around the perimeter 90 of the element 22. The trimming can be performed using for example steel rule die cutting, matched metal dies, or laser trimming. As a general rule the steel rule die cutting would be used for two-dimensional elements whereas the matched metal dies would be used for three dimension elements.

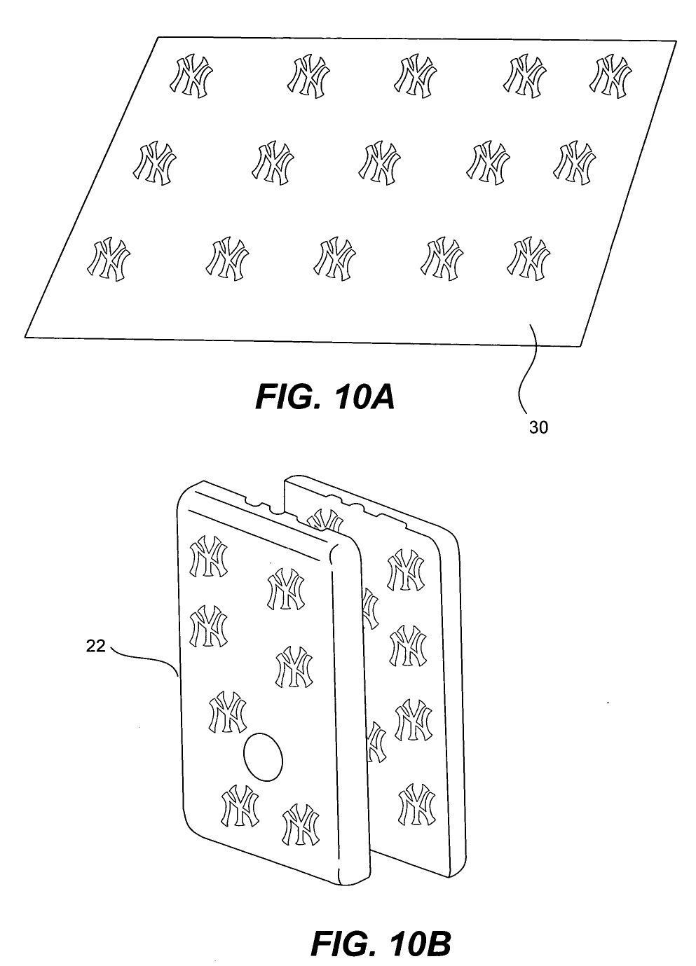

FIGS. 10A and 10B show yet another embodiment of the present invention. With this embodiment, the bulk sheets 30 are printed with decorative imagery. In the example shown, the image is the logo for the NY Yankees baseball team. It should be noted, however, that the sheet 30 can be printed with any logo or imagery, such as but not limited to a sports team logo, the logo of a popular product such as Coca Cola or Harley Davidson, a flag or other patriotic symbol, a photograph, or any other desirable image. The bulk sheets 30 can be printed in one of a variety of ways, such as using a digital press, silk screening, four color press, or any other printing process.

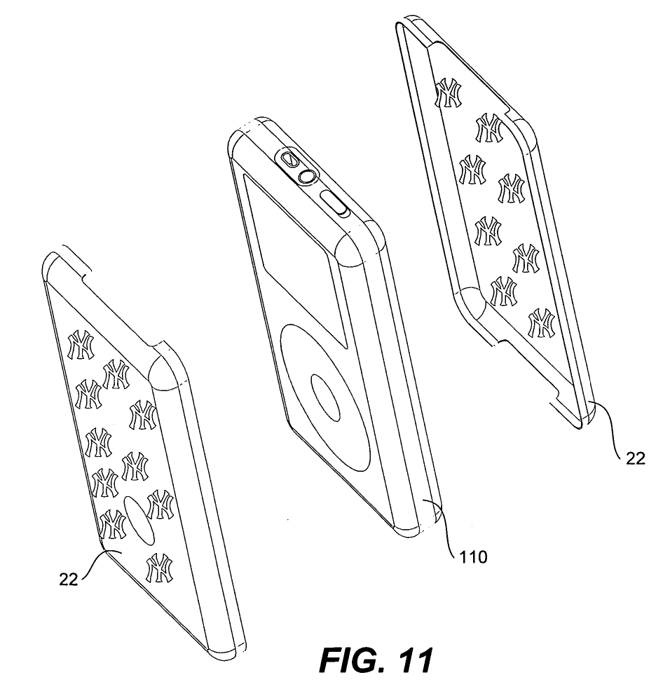

Referring to FIG. 11, a diagram illustrating elements 22 and 24 with the NY Yankee logo printed thereon is shown. The two elements are placed over and used to protect an Apple Ipod™ 110. Again it should be noted that the elements 22 and 24 can be molded to form-fit any product, and not just the Apple Ipod™ as illustrated.

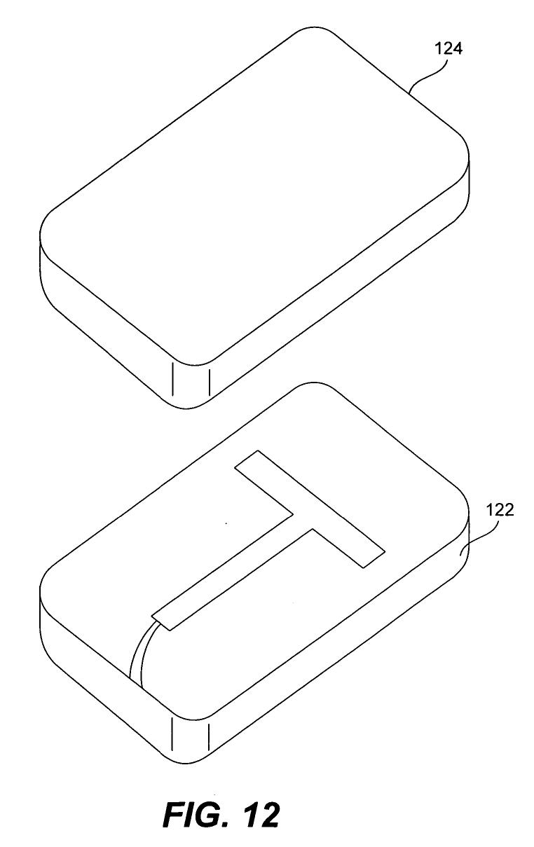

Referring to FIG. 12, a molded element having a conductive circuit printed thereon is shown. The element 120 has a metal circuit 122 that is printed thereon. According to various embodiments, the metal circuit can be made from any conductive material, such as aluminum or gold. It can be printed onto the element 120 prior to its being molded while still in bulk film form. For example, the metal circuit can be printed onto the film in a number of ways, for example by silk screening, digital press, color press, or any other printing process capable of printing a conductive metal or ink. The circuit 122 can be any type of circuit, for example an antenna for a cell phone or a portable radio. In other embodiments, the printed circuit can be used for implementing a touch sensitive control surface or status indicator, etc. with the addition of discrete components (such as resistors, diodes, ICs. In yet another embodiment, a second element 124 may be used to cover the first element 120 with the printed circuit 122 formed thereon. The second element is form-fitted to the first element 120 and is designed to fit over and protect the printed circuit 122. The second element 124 can be either transparent, opaque, colored, and/or have a decorative logo or imagery formed thereon.

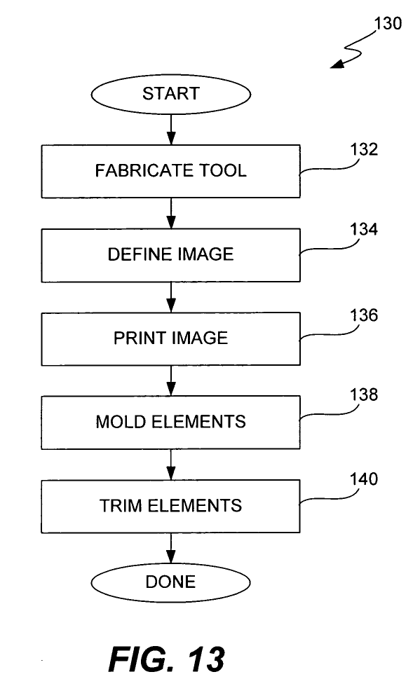

Referring to FIG. 13, a flow chart illustrating the sequence of making elements configured to form-fit another product is shown. In the initial step, the tool 10 is fabricated (box 132). Next the image to appear onto the elements is defined (box 134) and then printed onto the bulk sheet 30 (box 136). Thereafter, the sheet is molded using any of the above described techniques to form the elements (box 138). In the final step, the bulk sheet material is trimmed (box 140), excising the elements from the bulk material.

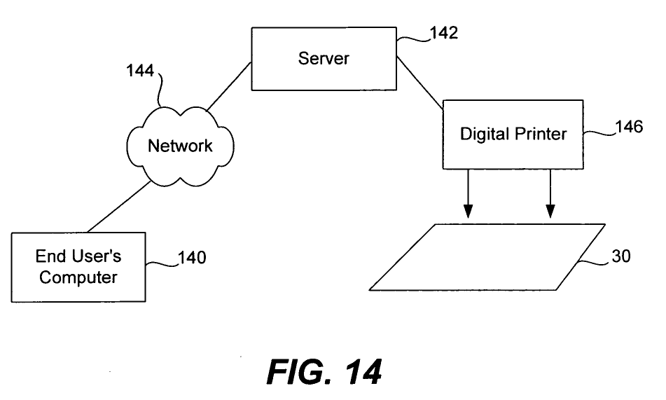

Referring to FIG. 14, a diagram illustrating the receipt and printing of an image onto the bulk film used to make the molded elements according to the present invention is shown. In the diagram, an end user, such as a customer, using a computer 140 uploads an image file to a server 142 via a computer network 144, such as the Internet. The server 142 then manipulates the file as necessary and provide the image file to a digital printer 146. The image defined by the image file is then printed onto the bulk film material 30. After the image is printed, the film 30 can be molded using any of the above-described embodiments. In this manner, protective case for a product with virtually any image printed thereon can be easily and readily made. For example, a favorite photograph, image, logo, etc. can be printed onto the protective case.

Although the foregoing invention has been described in some detail for purposes of clarity of understanding, it will be apparent that certain changes and modifications may be practiced within the scope of the appended claims. Therefore, the described embodiments should be taken as illustrative and not restrictive, and the invention should not be limited to the details given herein but should be defined by the following claims and their full scope of equivalents.

We claim:

1. A method, comprising:
creating a tool having substantially the same surface dimensions of a product;
molding an element from bulk film material using the tool, the element configured to form-fit the product; and
trimming the element from the bulk film material.

2. The method of claim 1, further comprising printing a decorative image onto the bulk film material prior to molding the bulk film material so that the decorative image appears on the element after it has been molded.

3. The method of claim 1, further comprising printing the decorative image using one of the following printing methods: a digital press; silk screening, or a color press.

4. The method of claim 1, further comprising printing an electronic circuit onto the bulk film material prior to molding the bulk film material so that the electronic circuit appears on the element after it has been molded.

5. The method of claim 4, further comprising printing a conductive metal onto the bulk film material to form the electronic circuit.

6. The method of claim 4, further comprising printing a conductive ink onto the bulk film material to form the electronic circuit.

7. The method of claim 1, wherein molding the element from the bulk film material further comprises heating the bulk film material so that it conforms to the shape of the tool.

8. The method of claim 1, wherein molding the element from the bulk film material further comprises using a vacuum to pull the bulk film material onto the tool so that it conforms to the shape of the tool.

9. The method of claim 1, wherein molding the element from the bulk film material further comprises squeezing the bulk film between a male and a female tool to mold the bulk film material.

10. The method of claim 1, wherein molding the element from the bulk film material further comprises clamping the bulk film material over the tool to assist the bulk film material in conforming to the shape of the tool.

11. The method of claim 1, wherein molding the element from the bulk film material further comprises applying air pressure onto the bulk film material so that it conforms to the shape of the tool.

12. The method of claim 1, wherein molding the element from the bulk film material further comprises applying a pressurized bladder onto the bulk film material so that it conforms to the shape of the tool.

13. The method of claim 1, wherein molding the element from the bulk film further comprises:
inserting the bulk film material and tool into a chamber;
heating the bulk film material adjacent the tool; and
pressurizing the chamber to compensate for any sag of the bulk film material caused by heating the bulk film material.

14. The method of claim 1, wherein trimming the element from the bulk film material further comprises cutting the bulk film material along the X and Y directions to excise the element from the bulk film material after molding.

15. The method of claim 1, wherein trimming the element from the bulk film material further comprises cutting the bulk film material along the Z direction to excise the element from the bulk film material after molding.

16. The method of claim 1, wherein trimming the element from the bulk film material further comprises using one of the following trimming techniques: steel rule die cutting; matched metal die cutting; or laser cutting.

17. The method of claim 1, further comprising:
receiving an image over a computer network;
providing the image to a digital printer;
printing the image onto the bulk film material prior to molding the bulk film material.

18. An apparatus, comprising a protective case intend to form-fit over the surface features and dimensions of a product, the protective case made from a molded thermoplastic material excised from a bulk sheet of the thermoplastic material.

19. The apparatus of claim 18, wherein the thermoplastic material comprises but is not limited to of one of the following: a polycarbonate, acrylonitrile butadiene styrene, polyvinyl chloride (PVC), polypropylene, acrylic, celluloid,

20. The apparatus of claim 18, wherein the molded thermoplastic material has one or more of the following aesthetic characteristics: clear, opaque, or colored.

21. The apparatus of claim 20, wherein the molded thermoplastic material has a decorative image printed thereon.

21. The apparatus of claim 20, wherein the molded thermoplastic material has electronic circuitry printed thereon.

22. The apparatus of claim 18, wherein the protective case has a first member intended to cover and protect the first side of the product and a second member intended to cover and protect the second side of the product.

23. The apparatus of claim 21, wherein further comprising a second member, made of molded thermoplastic material, and designed to form-fit over the molded thermoplastic material having the electronic circuitry printed thereon for the purpose of protecting the electronic circuitry.
